(19) United States
(12) Patent Application Publication
(10) Pub. No.: US 2015/0154092 A1
(43) Pub. Date: Jun. 4, 2015

(54) BIOS MAINTENANCE METHOD

(71) Applicants: INVENTEC CORPORATION, Taipei City (TW); INVENTEC (PUDONG) TECHNOLOGY CORPORATION, Shanghai (CN)

(72) Inventor: TING-TING CHEN, Shanghai City (CN)

(73) Assignees: INVENTEC CORPORATION, Taipei City (TW); INVENTEC (PUDONG) TECHNOLOGY CORPORATION, Shanghai (CN)

(21) Appl. No.: 14/168,425

(22) Filed: Jan. 30, 2014

(30) Foreign Application Priority Data
Nov. 29, 2013 (CN) 201310629866.4

(51) Int. Cl. G06F 11/22

(52) U.S. Cl. CPC G06F 11/2284

(57) ABSTRACT

Disclosed herein is a BIOS (basic input/output system) maintenance method. A remote management console obtains a first BIOS setting from a first memory of a server through a baseboard management controller of the server, the first memory coupled with the baseboard management controller. The first BIOS setting is remotely modified and saved back into the first memory through the baseboard management controller. A BIOS of the server then loads the modified first BIOS setting to become operational.

### CROSS-REFERENCE TO RELATED APPLICATIONS

This non-provisional application claims priority under 35 U.S.C. §119(a) on Patent Application No. 201310629866.4 filed in People's Republic of China on Nov. 29, 2013, the entire contents of which are hereby incorporated by reference.

### TECHNICAL FIELD

The present invention relates to server technology, particularly to a BIOS (basic input/output system) maintenance method.

### BACKGROUND

When a server is powered up, its BIOS performs power-on self-test (POST) for it to initialize the swarm of components on the motherboard and provide the necessary runtime environment for the operating system. It is required prior to the initialization that the BIOS load its setting, which may include the boot device sequence or whether some specific function should be enabled on the motherboard. Modifications to the setting often take place locally in the BIOS setup menu, an inconvenient and sometimes challenging practice especially when there is not one server, but a data center's worth of servers to be maintained.

### SUMMARY

In light of the above, the present invention discloses a method for maintaining a BIOS of a server from a remote management console which obtains a first BIOS setting from a first memory through a baseboard management controller (BMC). The first memory and the BMC, components of the server, are coupled with each other. The first BIOS setting is modified at the remote management console, and stored into the first memory through the BMC. The BIOS then loads the modified first BIOS setting to become operational.

In one embodiment, when the BIOS loads the first setting, the BIOS obtains through the BMC the modified first BIOS setting in the first memory, writes the modified first BIOS setting into a second memory of the server, and, upon a restart of the server, retrieves the modified first BIOS setting from the second memory to load the modified first BIOS setting to become operational. In one embodiment, a second BIOS setting is stored beforehand in the second memory, and the modified first BIOS setting is written into the second memory by replacing the second BIOS setting in the second memory with the modified first BIOS setting. In one embodiment, before the server is restarted the BIOS has loaded the second BIOS setting to become operational. In one embodiment, the server is directed by the remote management console through the BMC to restart. In one embodiment, the second memory is a complementary metal-oxide-semiconductor (CMOS) storage chip.

In one embodiment, a verification value corresponding to the first BIOS setting is stored in the first memory and updated so that it corresponds to the modified first BIOS setting.

In one embodiment, when the remote management console obtains the first BIOS setting from the first memory through the BMC, the BMC receives a data acquisition command from the remote management console, reads the first BIOS setting in the first memory, and sends the first BIOS setting to the remote management console, based on the data acquisition command.

In one embodiment, the first BIOS setting is displayed and modified on a display interface of the remote management console. In one embodiment, the first BIOS setting is displayed on the display interface as a mapping table, and a user modifies the contents of the mapping table to realize the modification to the first BIOS setting.

In particular, the remote management console sends the BMC a data acquisition command and modifies the first BIOS setting that is backed up in the first memory. The BIOS may load the modified first BIOS setting at a later time, so that expeditious maintenance of and modification to the setting data of the BIOS are realized.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a high-level block diagram of a server, in accordance with one embodiment of the present invention.

FIG. 2 is a flowchart illustrating in part a BIOS maintenance method, in accordance with one embodiment of the present invention.

FIG. 3 is a flowchart illustrating in part a BIOS maintenance method, in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

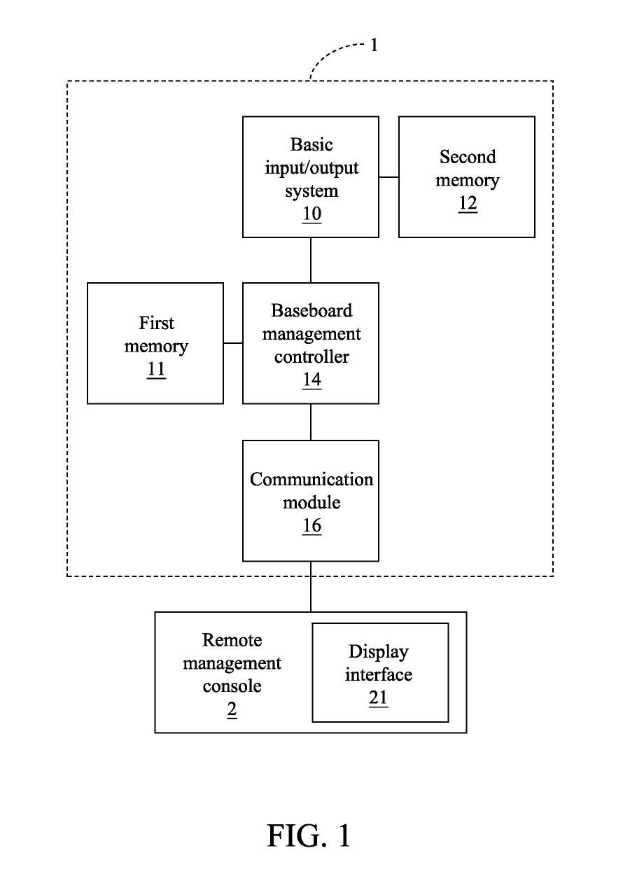

Please refer to FIG. 1. As shown in this high-level block diagram, in one embodiment, a server 1 comprises a BIOS (basic input/output system) 10, a baseboard management controller (BMC) 14, a communication module 16, a first memory 11, and a second memory 12. The communication module 16 may be a wired or wireless network interface card (NIC), which through a network the BMC 14 is coupled with a remote management console 2, which may include a display interface 21. The first memory 11 may be coupled with the BMC 14 on an I²C (Inter-Integrated Circuit) or a SPI (Serial Peripheral Interface) bus, while the second memory 12 is coupled with the BIOS 10. To streamline the description, the central processing unit (CPU), volatile random-access memory used by the CPU (e.g. a dual in-line memory module or DIMM), heat-dissipation modules, power supply, hard disk drives, RAID (redundant array of independent disks) card, sensors for the aforementioned hardware, etc. that the server 1 may further include are not depicted in FIG. 1.

As the processing core of the Intelligent Platform Management Interface (IPMI), the BMC 14 monitors sensors at multiple locations within the server 1 to determine and automatically report the temperature, power stability, and other operational status of the server 1. The BMC 14 may also cause the server 1 to start up or shut down. In one embodiment, the server 1 may be started up with the use of a power button on a motherboard of the server 1. The first memory 11 and the second memory 12 may be flash memory, other types of electrically erasable programmable read-only memory (EEPROM), or other non-volatile storage. In one embodiment, the second memory 12 is a complementary metal-oxide-semiconductor storage chip, volatile but equipped with a battery, and dedicated to the storage of the setting data of the BIOS 10.

The operation of the BIOS 10 involves the CPU and a dedicated read-only memory storing the machine code that the CPU first reads according to its program counter when the server 1 is powered on. The CPU is bestowed with the capabilities of the BIOS 10 by executing this machine code. Generally speaking, the BIOS 10 can be seen as a complete and independent function block. The coupling between the BIOS 10 and the BMC 14 may be, but is not limited to, a LPC (Low Pin Count) bus. The BIOS usually loads from the second memory 12 its setting (the second BIOS setting), but in the present invention a backup setting (the first BIOS setting) stored in the first memory 11 is also available to the BIOS 10 through the BMC 14.

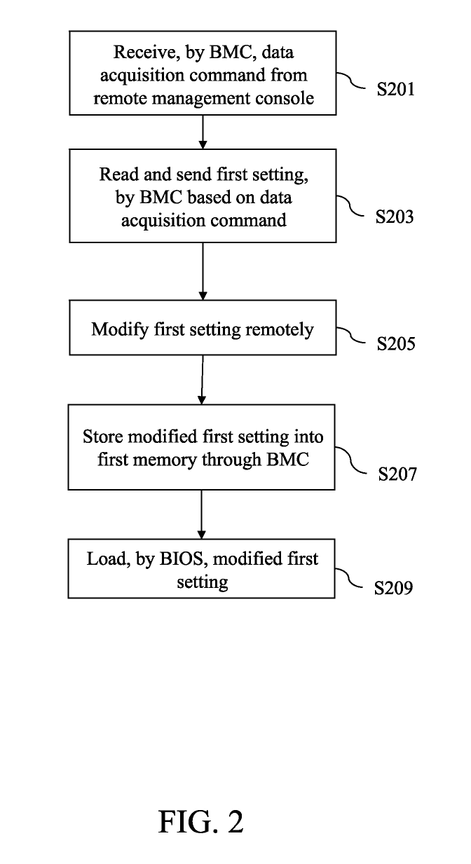

Please refer to FIG. 2 with regard to FIG. 1. The flowchart illustrates the steps of obtaining, modifying, and repositing the first BIOS setting. As shown in FIG. 2, the BMC receives a data acquisition command from the remote management console 2 through the communication module 16 in step S201. The remote management console 2 asks for the setting data of the BIOS 10, specifically the portion it is interested in or wants to modify, from the BMC 14 with the data acquisition command. In step S203, the BMC 14 obtains from the first memory 11 the first BIOS setting and sends it through the communication module 16 based on the data acquisition command. A user then remotely modifies the first BIOS setting in step S205; for example, the user modifies the first BIOS setting at the remote management console 2. In particular, the remote management console 2 may display the first BIOS setting on the display interface 21 for user modification. In one embodiment, the first BIOS setting is displayed as a mapping table, the modification to whose contents by the user is equivalent to the modification to the first BIOS setting. In step S207, the modified first BIOS setting travels through the network and the communication module 16 and is stored back into the first memory 11 by the BMC 14. In one embodiment, the BMC 14 ignores the data acquisition command or reports an error through the communication module 16 when it does not recognize the command or when the command is not supported by the BIOS 10. The BIOS 10 loads the modified first BIOS setting in step S209.

Please note that in one embodiment, any access to the first or second BIOS setting includes taking the setting as a bit string and calculating a verification value thereof so as to verify the correctness and authenticity of the bits. The verification value may be a simple checksum or a hash value, such as the outcome of a function of the CRC (cyclic redundancy check) series. The calculation of verification values of the settings of the BIOS 10 is well known by persons skilled in the art and may be performed by the BIOS 10, the BMC 14, or the remote management console 2.

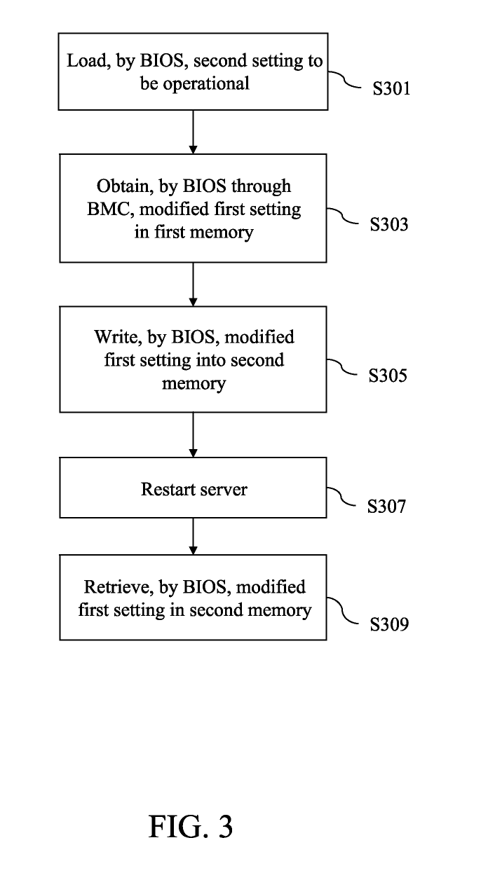

Please refer to FIG. 3 with regard to FIG. 1. Supplementing FIG. 2, this flowchart illustrates the steps of the BIOS 10 loading its setting before and after a restart of the server 1. As shown in FIG. 3, the BIOS 10 is running upon the second BIOS setting (step S301) before the server 1 is restarted. Steps S303 to S309 are an expansion of step S209 in FIG. 2. The BIOS 10 obtains through the BMC 14 in step S303 the modified first BIOS setting in the first memory 11, and in step S305 writes the obtained first BIOS setting into the second memory 12, replacing the second BIOS setting originally stored therein. After the server 1 is restarted in step S307 (which may be effected by the remote management console 2 through the BMC 14), the BIOS 10 reads from the second memory 12 and loads the first BIOS setting written in step S305 to become operational.

In short, to remotely modify the configuration data of the BIOS, the first BIOS setting is obtained through the BMC, modified, and saved back to the first memory by the remote management console extraneous to the server, and finally loaded by the BIOS. The present invention provides a means by which a user is able to read and modify BIOS settings without having to physically enter a data center or server room, and whose convenience and advantages are more evident when the machines to be maintained are many.

What is claimed is:

1. A BIOS (basic input/output system) maintenance method comprising:
obtaining, by a remote management console, a first BIOS setting from a first memory of a server through a baseboard management controller (BMC) of the server, the first memory coupled with the BMC;
modifying the first BIOS setting at the remote management console;
storing the modified first BIOS setting into the first memory through the BMC; and
loading, by a BIOS of the server, the modified first BIOS setting.

2. The BIOS maintenance method of claim 1, wherein loading the modified first BIOS setting comprises:
obtaining, by the BIOS through the BMC, the modified first BIOS setting in the first memory;
writing, by the BIOS, the modified first BIOS setting into a second memory of the server;
restarting the server; and
retrieving, by the BIOS, the modified first BIOS setting from the second memory to load the modified first BIOS setting to become operational.

3. The BIOS maintenance method of claim 2, wherein a second BIOS setting is stored beforehand in the second memory, and writing the modified first BIOS setting into the second memory is replacing the second BIOS setting in the second memory with the modified first BIOS setting.

4. The BIOS maintenance method of claim 3, wherein before the server is restarted the BIOS loads the second BIOS setting to become operational.

5. The BIOS maintenance method of claim 2, wherein restarting the server comprises directing, by the remote management console through the BMC, the server to restart.

6. The BIOS maintenance method of claim 2, wherein the second memory is a complementary metal-oxide-semiconductor storage chip.

7. The BIOS maintenance method of claim 1, wherein a verification value corresponding to the first BIOS setting is stored in the first memory, and the BIOS maintenance method further comprises updating the verification value so that the verification value corresponds to the modified first BIOS setting.

8. The BIOS maintenance method of claim 1, wherein obtaining the first BIOS setting from the first memory through the BMC comprises:
receiving, by the BMC, a data acquisition command from the remote management console; and
reading, by the BMC, the first BIOS setting in the first memory and sending, by the BMC, the first BIOS setting to the remote management console, based on the data acquisition command.

9. The BIOS maintenance method of claim 1, wherein modifying the first BIOS setting comprises:
displaying the first BIOS setting on a display interface of the remote management console; and
modifying the first BIOS setting on the display interface.

10. The BIOS maintenance method of claim 9, wherein the first BIOS setting is displayed on the display interface as a mapping table, and said modifying the first BIOS setting on the display interface comprises modifying, by a user, the contents of the mapping table to realize the modification to the first BIOS setting.
